(19) United States
(12) Patent Application Publication
(10) Pub. No.: US 2023/0080309 A1
(43) Pub. Date: Mar. 16, 2023

(54) Generation of ML Models and Recommendations with Unstructured Data

(71) Applicant: GeniusMesh Corporation, Alpharetta, GA (US)

(72) Inventor: Neerja Bharti, Alpharetta, GA (US)

(21) Appl. No.: 17/945,041

(22) Filed: Sep. 14, 2022

Related U.S. Application Data
(60) Provisional application No. 63/244,011, filed on Sep. 14, 2021.
(60) Provisional application No. 63/244,005, filed on Sep. 14, 2021.
(60) Provisional application No. 63/244,023, filed on Sep. 14, 2021.

(51) Int. Cl. G06Q 10/10; G06N 3/04; G06N 3/08

(52) U.S. Cl. CPC G06Q 10/1053; G06N 3/0427; G06N 3/08

(57) ABSTRACT

Exemplary embodiments of the invention can include a method for receiving a resume from a candidate, processing the resume to generate machine-readable candidate resume data, providing the machine-readable candidate resume data to a rules-based engine to generate matching career levels for the candidate, providing the machine-readable candidate resume data to an alternative career rules-based engine to generate alternative career levels for the candidate, and generating a candidate report including the matching career levels and the alternative career levels.

### CROSS REFERENCE TO RELATED APPLICATIONS

This application claims the benefit of the following applications: U.S. Provisional Application No. 63/244,023 filed Sep. 14, 2021, U.S. Provisional Application No. 63/244,011, filed Sep. 14, 2021, and U.S. Provisional Application No. 63/244,005, filed Sep. 14, 2021. These applications are incorporated by reference herein and considered a part of this disclosure.

### FIELD OF THE ART

This disclosure relates to systems and methods for analyzing professional skills and making career advancement evaluations and recommendations.

### DISCUSSION OF THE STATE OF THE ART

In today's economy, advancing within a career path, and switching careers within or outside of an organization or an industry is more difficult and more complex than ever. Generally, career advancement today often requires some mix of hyper-specialization combined with cross-functional skills. Moreover, making the process more difficult, traditional well-tread career pathways are becoming more obscure as traditional job functions are replaced or shifted to accommodate global competition and digital commerce. In addition, the advent of social networking systems has created an echo-chamber around specific industries, which on the one hand, have made it easy to connect with others within the same industry, but, on the other hand, have made other, unrelated industries much more opaque and difficult to break into. As a result, workers in today's economy are finding it more difficult than ever to advance their career or to break into new careers or new industries.

Currently available solutions that help employees overcome these problems are ad-hoc, require individualized coaching, expensive and are generally ineffective. Individualized coaching is undesirable because of the high levels of human capital required. Moreover, and just as importantly, these solutions are not scalable because of the very nature of individualized coaching. Individualized coaching is also limited in effectiveness because these programs are highly reliant on the coach's exposure to various industries and alternative career pathways that may be available to an employee, and because it is often very difficult to match a coach's experience with an employee's experience and desires. Currently, there are no systematic approaches for overcoming the problems that employees commonly face in today's employment marketplace.

### SUMMARY

The present invention overcomes the traditional challenges associated with career advancement assessments and guidance systems by computationally and algorithmically evaluating a candidate's resume, assessments, and other input data to provide career evaluation, resume evaluation, and career assessment based on user data and machine learning models. More specifically, the present invention uses machine learning models to provide a career evaluation (by, for example, suggesting alternative industries that the candidate may apply to), resume evaluation (by, for example, comparing the candidate's resume against others in a benchmark), and career assessment (by, for example, mapping the candidate's psychometric test data against requirements or preferences in various roles and positions). These evaluations enable candidates to determine whether a career pathway is appropriate for them, where their interests, personality and professional background aligns, identify gaps between career aspirations and professional experience and/or acquire skills and certifications that may be necessary to advance along a particular career pathway. This also helps candidates see how other people have taken incremental steps to reach the same career goal

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a block diagram of an operating environment, in accordance with an embodiment of the invention.

FIGS. 2a-2d illustrate block diagrams of systems for analyzing user data and providing career assessment and guidance.

FIGS. 3a-3d illustrate process diagrams of exemplary methods for analyzing user data and providing career assessment and guidance.

FIG. 4 illustrates an exemplary system block diagram for receiving and analyzing user data.

FIG. 5 illustrates an exemplary system block diagram for processing user data.

FIG. 6 illustrates an exemplary method for assessing testing data received from the user.

FIG. 7 is a block diagram illustrating an exemplary hardware architecture of a computing device, according to a preferred embodiment of the invention.

FIG. 8 is a block diagram illustrating an exemplary logical architecture for a client device, according to a preferred embodiment of the invention.

FIG. 9 is a block diagram showing an exemplary architectural arrangement of clients, servers, and external services, according to a preferred embodiment of the invention.

FIG. 10 is another block diagram illustrating an exemplary hardware architecture of a computing device, according to a preferred embodiment of the invention.

### DETAILED DESCRIPTION

The inventor has conceived, and reduced to practice, a system and method for analyzing user data and providing career assessments and guidance based on an analysis of the user data.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Conceptual Architecture

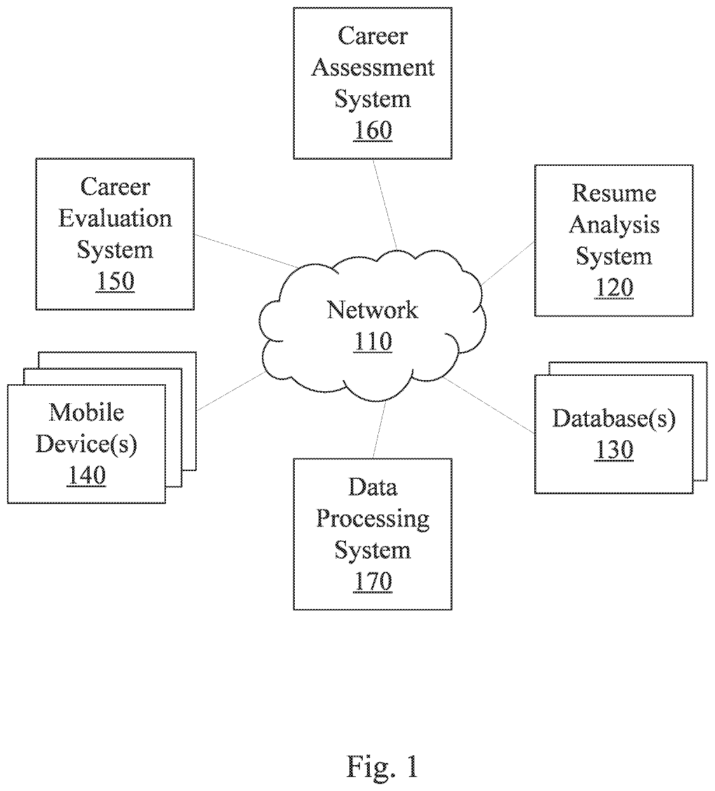

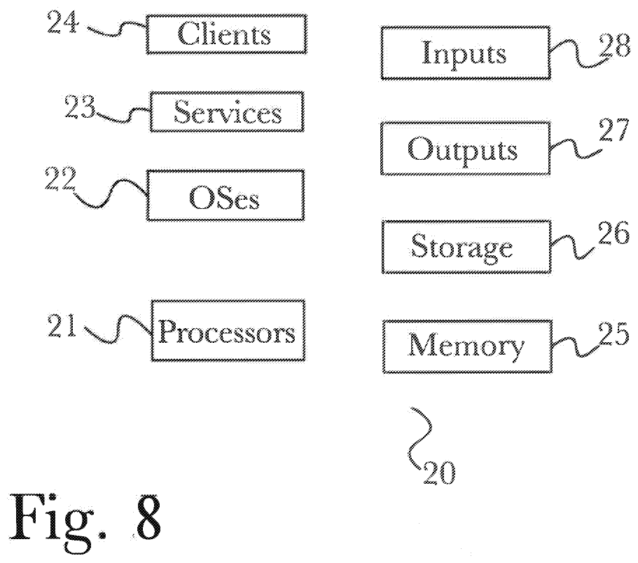

FIG. 1 is a block diagram of an exemplary operating environment, in accordance with an embodiment of the invention. It is comprised of network 110, data processing system 170, career evaluation system 150, resume analysis system 120, career assessment system 160, databases 130, and mobile device(s) 140. Although the various systems and subsystems are illustrated as one or more boxes in FIG. 1, it is noted that multiple instances of the disclosed systems and sub-systems may be present in various embodiments, and that references herein to a system or a sub-system (e.g., user devices 140, resume analysis system 120, etc.) generally refers to one or more of the systems or sub-systems. In an alternative embodiment, the functionalities of multiple agents may be merged, modified, or split into a functionally equivalent set of systems and sub-systems. The various computing agents may comprise one or more computing devices, like the computing device 10 illustrated in FIG. 5 and/or the computer system 40 illustrated in FIG. 8.

The data processing system 170 processes user data to make it machine readable, and generates training data sets for evaluating user data that may be acquired downstream. For example, the data processing system 170 processes resume data that a user may provide by applying stopward removal, punctuation removal, numbers removal, etc. Moreover, the data processing system 170 receives training data, including resumes and processes that data so that it may serve as training dataset for generating a trained ML model. In one embodiment of the invention the data processing system 170 parses user data and assigns a label to the data within one or more of the following categories: level, industry/focus-area, job roles, location, etc.

The career evaluation system 150 assesses the data that is parsed by the data processing system 170 and applies ML models to suggest alternative options that may be available to the user. For example, the career evaluation system 150 may suggest alternative industries, alternative career paths, alternative job roles, etc. that a user may thrive in based on his or her background by applying the ML model.

The resume analysis system 120 analyzes one or more candidates' resume to identify one or more areas that may be relevant for matching the candidate to a job opening. In one embodiment, the resume analysis system 120 collects one or more resumes, obtains tags, converts the file format and extracts relevant data from the resume, preps the data to make it more suitable for modelling, and applies a machine learning model to perform evaluation on the data against a benchmark group of resumes. The resume analysis system 120 may output recommendations based on the benchmark comparisons.

The career assessment system 160 evaluates candidates' aptitude for a particular job, organization, or a career path based on a variety factors. In one embodiment of the invention, the career assessment system 160 uses one or more personality trait scores to identify the types of organizations that the candidate may thrive in. In other embodiments, the career assessment system 160 uses one or more sociographic test data to make an assessment as to whether a position may be a good cultural fit for the candidate, including but not limited to: personality and leadership test, where the candidate is initially given a set of questions corresponding to each personality trait to analyze the personality and leadership quality and feedbacks are provided based on the responses. In order to identify the organizational preferences of the candidate, a set of options are given to the candidate among with he/she has to make choices. To identify the factors that motivates the candidates, a set of questions may be given for each factor and conclusions may be drawn based on the responses. Based on the scores for each of the personality trait, the suitable careers for the candidate are assessed. For each of the levels, the candidate's personality trait score and the required score are compared, thus making it easy for the candidate to identify his/her strengths and areas that needed improvement. The candidate's scores are also compared against scores required for various executive level roles e.g., CEO, COO thus making it easy for the candidate to understand gaps they need to work on. It also suggests how one may reach from his/her current career level to a career aspiration level in incremental steps.

The database(s) 130 refers to one or more resume repositories that may store resumes and/or professional background/experience information which may be used by the resume analysis system 120.

In particular embodiments, each user device 140 may be an electronic device including hardware, software, or embedded logic components or a combination of two or more such components and capable of carrying out the appropriate functions implemented or supported by the user device 140. For example, and without limitation, a user device 140 may be a desktop computer system, a notebook computer system, a netbook computer system, a handheld electronic device, or a mobile telephone. The present disclosure contemplates any user device 140. A user device 140 may enable a network user at the user device 140 to access network 110. A user device 140 may enable its user to communicate with other users at other user devices 140.

A user device 140 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 140 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 140 one or more Hyper Text Markup Language (HTML) files responsive to the HTTP request. The user device 140 may render a web page based on the HTML files from server for presentation to the user. The present disclosure contemplates any suitable web page files. As an example, and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 140 may also include an application that is loaded onto the user device 140. The application 140 obtains data from the network 110 and displays it to the user within an application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

The network 110 connects the various systems and computing devices described or referenced herein. In particular embodiments, network 110 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 110. The present disclosure contemplates any suitable network 110.

One or more links couple one or more systems, engines or devices to the network 110. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 110.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients' devices or other devices in response to HTTP or other requests from clients' devices or other devices. A mail server is generally capable of providing electronic mail services to various clients' devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a non-relational database (e.g., Mongo database application). Particular embodiments may provide interfaces that enable servers or clients to manage, e.g., retrieve, modify, add, or delete, the information stored in data storage.

### Detailed Description of Exemplary Embodiments

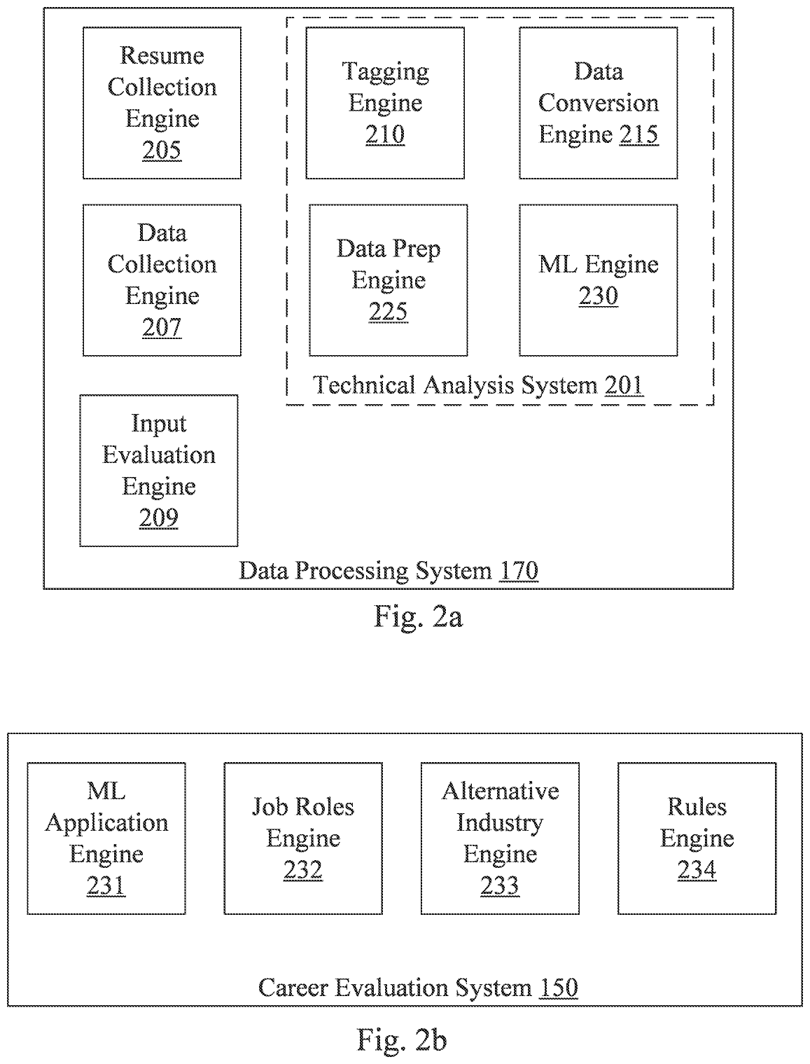

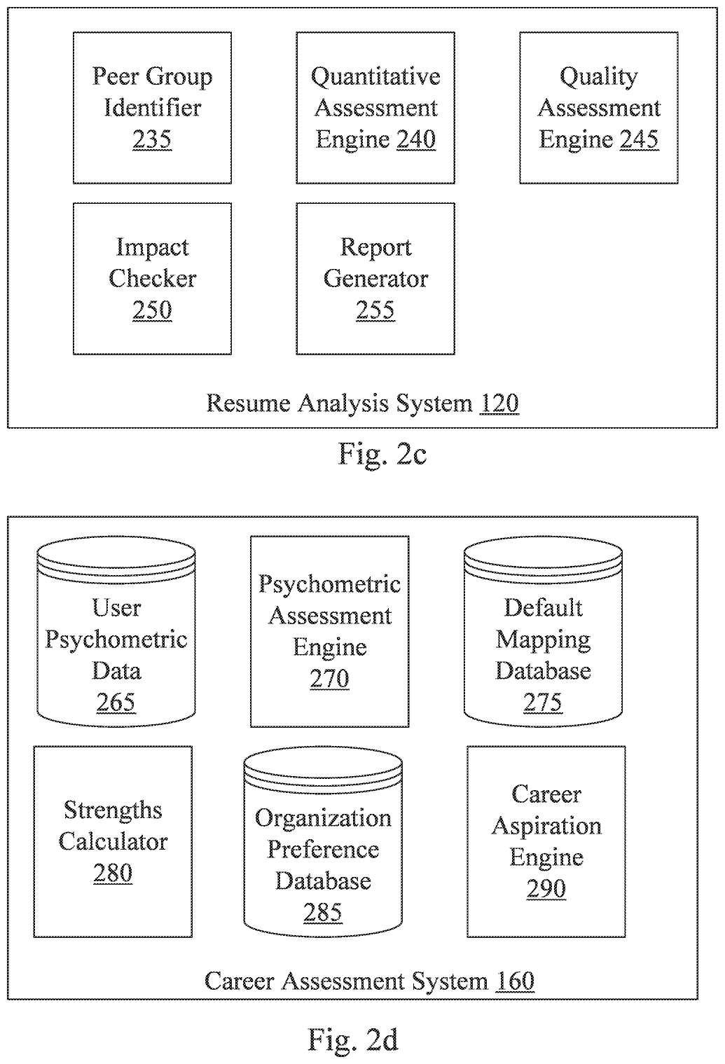

FIG. 2a is a block diagram illustrating an exemplary data processing system 170. It is comprised of a resume collection engine 205, a data collection engine 207, input evaluation engine 209, technical analysis system 201, which may be further comprised of tagging engine 210, data conversion engine 215, data prep engine 225, and ML engine 230.

The resume collection engine 205 collects resume from a user candidate who wishes to have his resume evaluated for effectiveness and/or job matching purposes. The user can upload the resume during the sign-up process or the process can be postponed to a later time. This can be done by either clicking on the “Upload Resume” button during sign up or “Upload New Resume” at a later time. The user can also replace the existing resume with an updated resume using the “Upload New Resume” once he is logged in. The resumes can be in either pdf, doc or docx format. Once the user completes the sign-up process and uploads his resume, the resume gets stored in the storage bucket, from where its contents are extracted and stored in the database.

The data collection engine 207 collects additional data about the user. In one embodiment of the invention, the data may be collected in the form of an answer to one or more questions that may be posed to the user. The responses may be tagged with meta tags to enable additional downstream processing as described herein. The rest of the data is collected from the profile creation process including but not limited to areas of interest, skills, current level and organization structure, salary requirements, and additional information shared by the user which can't be mentioned in the resume (for example, a user might mention that he is interested in transitioning industries or other functional areas a user might be interested in).

The input evaluation engine 209 creates a blended dataset based on information collected by the resume collection engine 205 and the data collection engine 207. In one embodiment of the invention, the input evaluation engine 209 identifies keywords and synonyms associated with one or more keywords in the data collected. This processing enables the system to benchmark the user data to other data that may be available in the training data set, and enables the ML engine 230 to run computation on the available data.

The technical analysis system 201 further analyzes the user data using computing technologies. For example, upon analyzing the candidate's resume, his/her educational qualifications, work experience, areas of interest, certifications and other information is used to tag the data with one or more relevant labels. In one embodiment, this can be done by passing the preprocessed user data to the machine learning model.

The tagging module 210 identifies tags and/or labels that may be applicable to one or more portions of the user's resume and user data. In one embodiment, the tagging may be performed algorithmically. However, in other embodiments, the tagging may be performed by a human and the results may be provided to the tagging module 210. In one embodiment of the invention, the resumes may be tagged by human experts can be used for training the machine learning model. The model learns a mapping between the resume content and the tags and applies this learning to tag the candidate's resume algorithmically. This learning is based on the presence of keywords, their associations and frequencies. Rule engine is also used to augment the performance of the machine learning model to tag the candidate's resume. More specifically, the tagging module 210 tags and/or labels the resume for a variety of factors, including, but not limited to the suitable levels for the candidate, primary industries that the candidates can work in, alternate industries based on the candidate's primary industry experience and the transferable skills of the candidate. The foregoing list is supplied herein by way of example and is not intended to limit the scope of the invention to only these tags or labels. Alternative tags or labels may be readily identified by a person of ordinary skill without departing from the scope of the invention.

The data conversion engine 215 converts user candidate's user data into an acceptable file format and cleans the resume content. It may, for example, remove irrelevant words, punctuations. It may also normalize words to their root word. For instance, the words ‘management’ and ‘manage’ may both be normalized to the word ‘manage,” etc.

The data prep engine 225 converts user candidate's resume data into a format that can be consumed by the machine learning system. The preprocessed data from the data conversion engine is then converted to word vectors using the vectorization model. A vectorizer model is created by identifying the vocabulary of the resumes that are tagged by human experts (training data) and creates a word—vector matrix. The preprocessed contents of the candidate's resume, which needs to be tagged algorithmically, is then converted to word—vector format using the vocabulary learned from the training data. This vectorized data is then used as an input to the machine learning system.

The ML engine 230 may use the prepped data as training data and/or use a trained model to analyze the user candidate's resume. The prepped data from the resumes that are tagged manually can be used to train the machine learning model. The sequential neural network model used learns a mapping between the words, their associations and frequencies, and the tags provided for a given number of iterations on the dataset. It stores a record of training loss values and metrics values at successive iterations. This model can then be used to predict the tags for a new resume. The model output is in the vector format which needs to be converted back to word format.

Referring now to FIG. 2b, illustrating a block diagram of the career evaluation system 150, which identifies alternative careers, alternative job roles, etc., that the user may be a good fit for. It is comprised of ML application engine 231, job roles engine 232, alternative industry engine 233, and rules engine 234.

The ML application engine 231, job roles engine 232, and alternative industry engine 233 suggest transferable skills, alternative job roles and/or alternative industries that may be available to the user based on ML models. This is done by applying some rules on the model output. These rules may be inferred by a human expert based on the industry experience and references. Once the model output in the vector format is converted back to text-readable format, each of the industry labels in the output is compared against the rules and the corresponding alternate industries may be suggested. In one embodiment of the invention, the suggestions may be limited to a pre-determined number, including, for example, 15 labels.

Referring now to FIG. 2c, illustrating a block diagram of the resume evaluation system 120, which evaluates the user's resume against a benchmark set of resumes. It is comprised of peer group identifier 235, quantitative assessment engine 240, quality assessment engine 245, impact checker 250, and report generator 255.

The quantitative assessment engine 240 evaluates various aspects of the user's resume. In one embodiment, the same tagging and analysis described above with respect to FIG. 2a with respect to tagging a training dataset, may be applied to the user's resume as well. In one embodiment, the quantitative assessment engine 240 determines the number of words, lines, paragraphs, etc., used in the user's resume. The quantitative assessment from each resume is stored in the database, which is used for doing a comparative analysis against an individual's corresponding peer group.

The peer group identifier 235 identifies peers or other job candidates who have comparable skill, background, experience, or impact as the user candidate. The peer group for the candidate is identified based on his level. For each level in tag list database, a file has been created containing the information about the training data set with that particular level. For each level, the number of resumes containing the level is calculated, counted the total number of words in all the resumes (these two features can be used to calculate the average number of words per resume), the action words and their counts in all the resumes, and the score corresponding to the sentences with impact words/phrases. This file can then be used to fetch the details of the peer group based the level with the highest score that was predicted for the candidate using the machine learning model.

The quality assessment engine 245 compares the candidate user's resume content with his or her peer group. The comparison helps the user to understand his position among the peers. The comparative analysis identifies the features the candidate has in common with the members in the same level, the features he/she needs to improve in order to be compatible with the peer group and the modifications that can be done in his resume to make it more appealing when compared to his/her peer group. It also evaluates the candidate's resume by assigning a score for each of these features.

In one embodiment of the invention, the quantitative assessment engine 240 also identifies sections of the user candidate's resume and creates a notification if one or more sections are missing. In one embodiment of the invention, for example, the section checker 240 may identify one or more of the following sections: re summary, educational details, certifications and languages known, etc. If any of these or other sections are missing, a notification may be generated. In one embodiment of the invention, the section checker 240 employs the follow system for identifying a section. This can be done as a two-step process. A file has been created with the titles of the sections a resume can have and the possible alternatives names the title can take. The resume content is compared with this list to identify the sections that are present in the resume. The list now contains the resume section in the order they appear in the resume. For each section, check whether the section name or any one of the possible alternatives is in the list. For the Summary section, the word count of the section is also calculated. The scores corresponding to the presence/absence of each section is also added to the total resume score.

The quality assessment engine 245 also identifies the rate at which action words are used in one or more sections and compares the rate to the rate of action word usage in the same or similar section in the user candidate's identified peer group. A few categories of action words have been identified and the lists of action words corresponding to each of these categories have been listed in separate files. For the peer group identified earlier, action words and their frequencies are identified for each category. This process can be repeated for the candidate's resume as well. In addition, categories can be identified with greater number of action words among the peer group, the average count for each action word in the peer group can be found as well as the average number of words per category. For the most common action words in the categories identified in the peer group, the words that are present can be checked in the candidate's resume as well. The quality assessment engine 245 also assigns the frequency of the word as the score, or in the absence thereof, it can assign zero as the score. The score corresponding to the presence/absence of action words is added to the total resume score.

The impact checker 250 can measure a number of lines indicating a user's measurable impact that is calculated from the resume and compares that calculated number with a similarly calculated number from the user candidate's peer group. For instance, a user resume can mention how he contributed by adding the sales in business or the revenue in business elucidates on the user's measurable impact. Similarly, measurable impact lines are calculated for the peer group. For the resumes in the peer group, the impact checker 250 can identify sentences with measurable impacts using pattern match and calculates the impact score by identifying the number of sentences with measurable impact out of the total sentences. The impact checker 250 repeats the same with the candidate's resume as well. Also list the sentences with and without measurable impacts. If there as more than 80% sentences with measurable impacts in the resume, add a full score corresponding to measurable impacts in the total resume score. Else reduce the score proportionately.

The report generator 255 generates a resume evaluation report that includes a summation or a summary of the user candidate's scores. The resume evaluation report includes the overall resume score, details about the contact information and the resume quality. The details of the contact information checks whether the resume contains the user name, the contact number, email id and LinkedIn URL. These are identified using pattern matching. The resume quality analyses whether the resume contains summary and if the summary has the length as prescribed, education details, professional certifications, languages and measurable impacts. It also shows the status of the measurable impacts as a separate window, with the lines with and without measurable impacts listed. The report suggests resume lines from successful resumes which can be suggested as guidance to modify the candidate's resume. The overall length of the resume is calculated in terms of the number of words and compared it with the average word count of the peer group resumes. The report also shows a comparison between the action words for the candidate's resume and that of the peer group for the top action word categories. The presence active voice is also ensured in the resume. The overall resume score is the aggregate of the scores of each of these sections.

FIG. 2d illustrates a block diagram of the career assessment system 160 in accordance with an embodiment of the invention. It is comprised of user psychometric data 265, psychometric assessment engine 270, default mapping database 275, strengths calculator 280, and organization preference database 285.

The psychometric data store 265 stores one or more users' responses to psychometric testing data. The psychometric assessment engine 270 tags the answers as belonging to one or more categories. For example, the psychometric assessment engine 270 tag answers as being relevant to personality traits, career aspirations, cultural assessment, organization preferences (which may be stored in the organization preference database 285), etc.

The strengths calculator 280 scores various personality traits based on a category or a type of question. The scores may be aggregated or averaged in a number of different ways to obtain insights onto the user along each category or type of question. In one embodiment of the invention, for example, for each of the personality traits listed, a set of predefined questions are given to the candidate and the responses are recorded. The score is calculated based on the response and question type and aggregate score for each personality trait is calculated and categorized into low, mid or high band. Based on the band the score falls in, the feedback is given to the user. Also based on the candidate's score for the personality traits, the most suited levels are suggested to him/her.

The career aspiration engine 290 identifies the gaps in the traits that a person possesses and the traits required for various leadership positions. For example, if a person or a candidate desires to be a chief operating officer (“COO”) for a company, the career aspiration engine 290 retrieves traits, and the levels of the trait that are generally desirable for the position, and compares those traits and levels with the traits and levels possessed by the person or the candidate. The difference between the levels are output to the user as gaps that the user should consider filling if he or she wants to obtain a job as a COO. Specifically, the career aspiration engine 290 generally stores various leadership, personality, technical skills, and professional experience required for various leadership roles. These various traits may be stored in a database along with a minimum score required for various job and/or leadership roles. The career aspiration engine 290 retrieves data from other parts of the system described herein for a candidate and groups or categorizes the various traits in one or more levels, including, for example, but not limited to low, medium and high. Then, based on your job or leadership role that a candidate aspires to, the career aspiration engine 290 identifies and retrieves scores associated with various leadership, personality, technical skills, and professional experience traits and identifies the differences or “gaps” between the desired score for each trait and the candidate's score. The “gap” analysis informs the candidate about the traits that he or she must improve if the candidate wants a chosen job or leadership role. It also informs the candidate whether he or she is a good fit for a role based on his or her personality. In the top user interface element, the results of the career aspiration engine 290 are displayed informing a candidate about a role that the user would be a good fit for based on his or her psychometric data. An exemplary user interface element could illustrate the candidate's score as compared to the general score for the position of CDO.

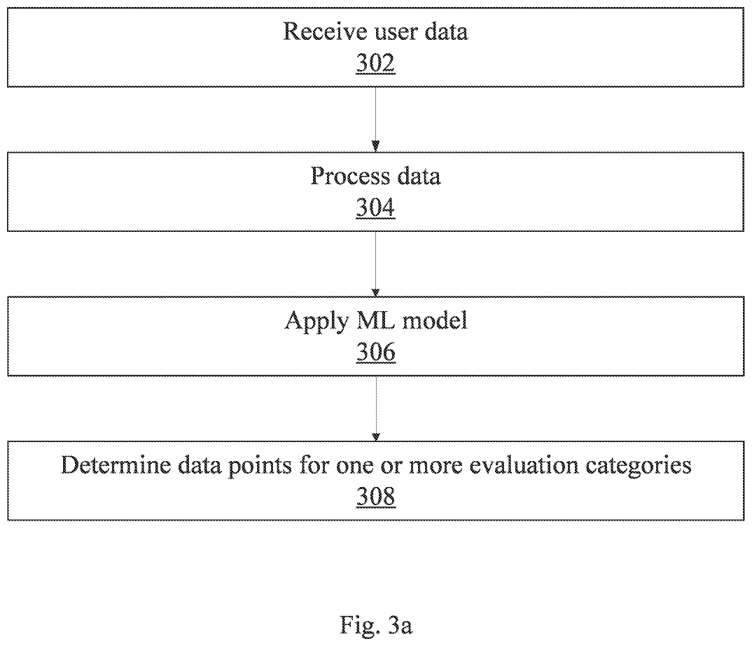

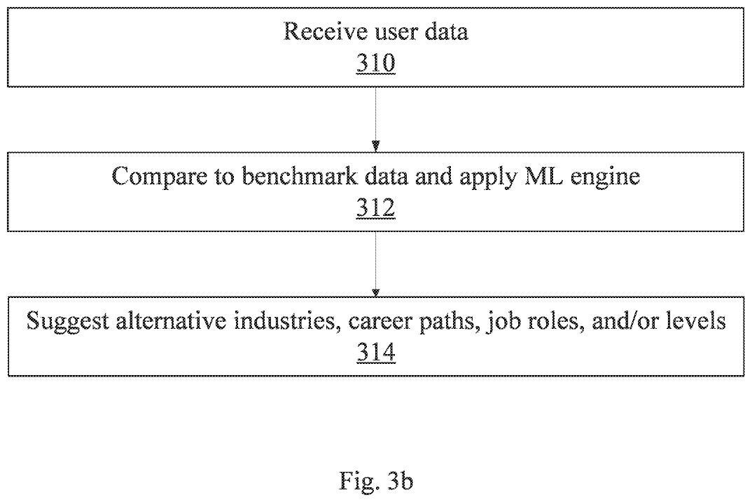

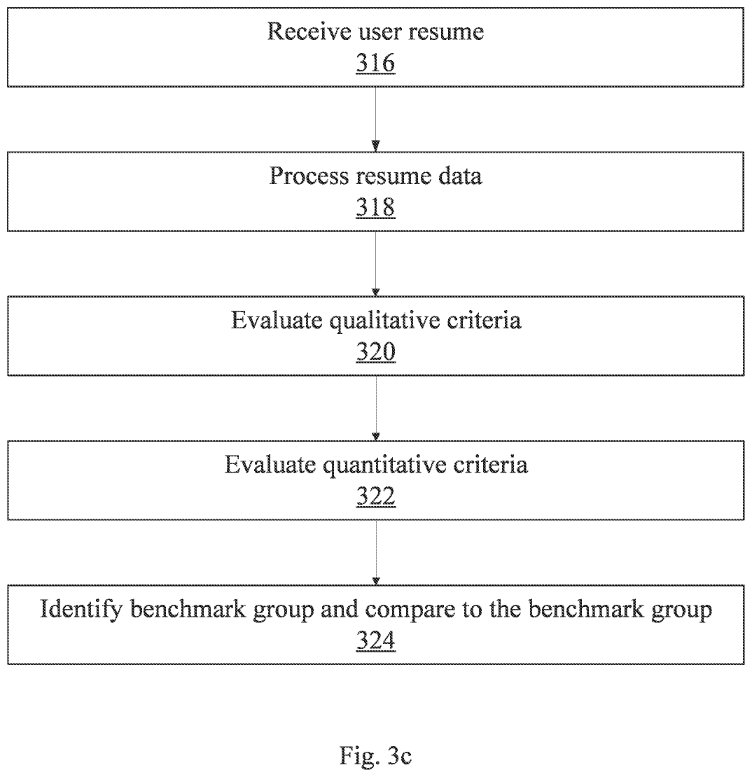

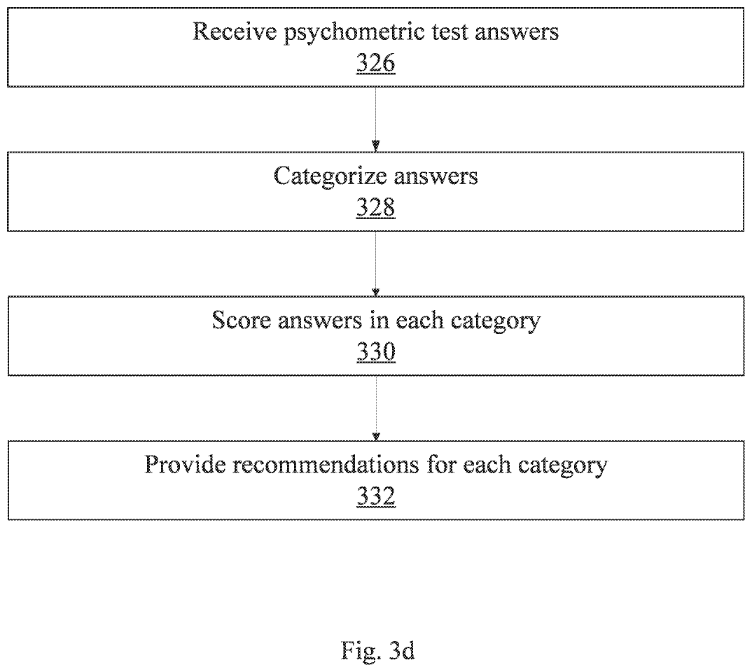

FIGS. 3a-3d are process diagrams for computationally analyzing user data and resume and making assessments on that data based on benchmarks. Generally, the process begins when user data is received including, but not limited to the user's resume, and other information provided by the user. The user data is processed, cleansed, and converted to vectors for processing by a machine learning model and rules engine to predict the corresponding tags, including a levels tag. Once the levels tag is identified, the resume is compared with benchmark data enabling the process to recommend alternative career paths, job roles, resume evaluation, and career assessment, including aptitude for one or more job roles or career paths based on psychometric test data and helps user to identify gaps in their leadership, personality and technical skills he/she needs to work on to be on the desired/aspired career path. The various leadership, personality, and technical skills are illustrated in representative figures. However, it should be noted that the figures are invention is not limited to the traits displayed in the figures.

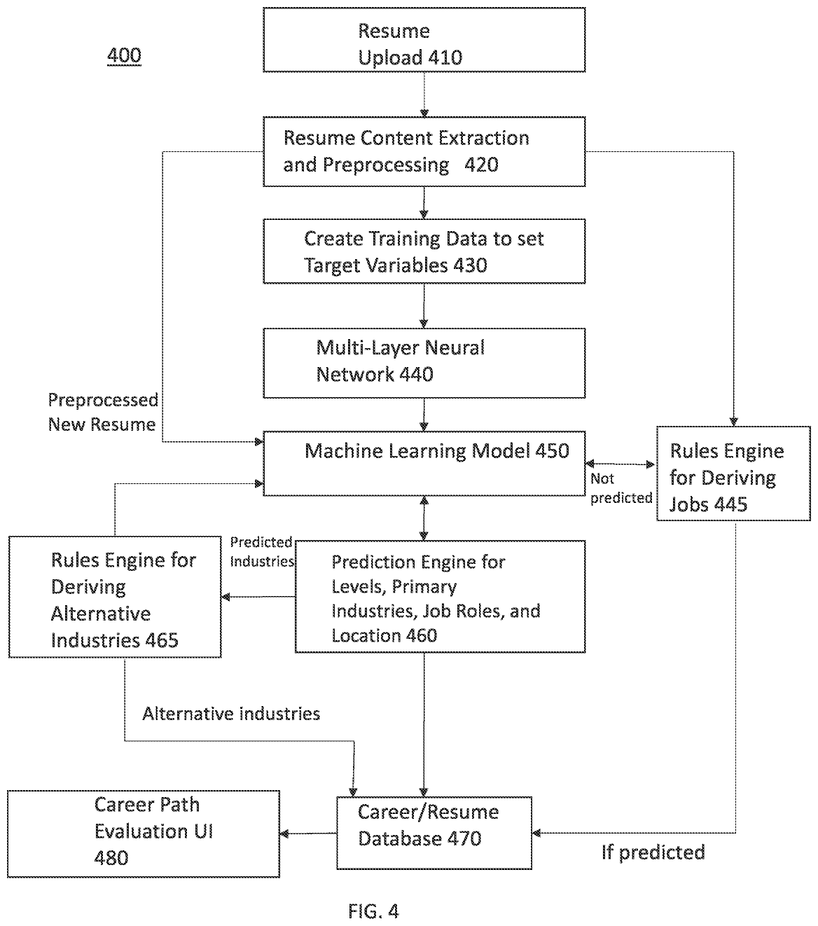

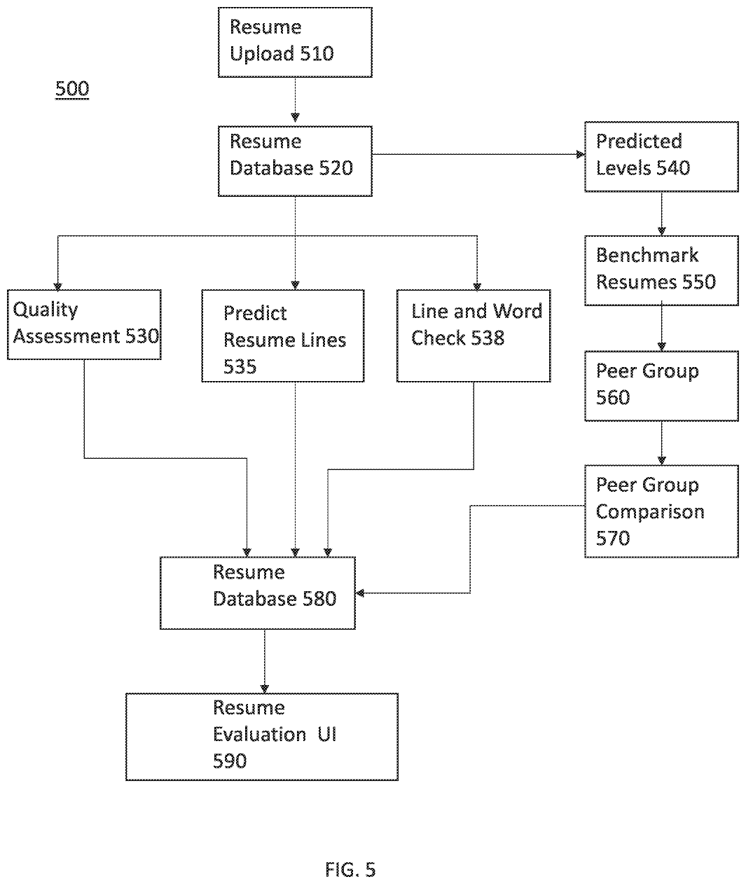

FIG. 3a illustrates an exemplary process in which user data, such as a candidate resume, is received in step 302. The resume is exemplarily processed in step 304 to achieve machine readable text in step 304. As discussed below in FIG. 4, a machine learning model is applied to the machine-readable text in step 306. Additionally, in step 308, data points for the resume are exemplary generated for evaluating the resume.

FIG. 3b illustrates another exemplary process in which the user data, such as the candidate resume or the machine-readable text from the processed candidate resume of step 304, is received. In step 312, the user data is compared to benchmark data, where the machine learning tools are applied to the user data. Exemplarily, in step 314, various recommendations can be made based on the comparison. In some instances, career paths, career levels, and job roles can be suggested. In other instances, alternative career paths and/or industries can be suggested.

FIG. 3c illustrates yet another exemplary process in which the user resume is received in step 316 and processed in step 318. In step 320, data from the processed resume is evaluated against qualitative criteria while in step 322, the data is evaluated against quantitative criteria. Exemplarily, in step 324, benchmarks can be applied to the processed resume as discussed below in FIG. 5. In some embodiments, a representative benchmark group can be identified. The identified benchmark group can include groups of resumes from other candidates in similar industries and/or career levels. Exemplarily, the candidate's resume can be compared against the representative benchmark group to determine the candidate's status within the benchmark group.

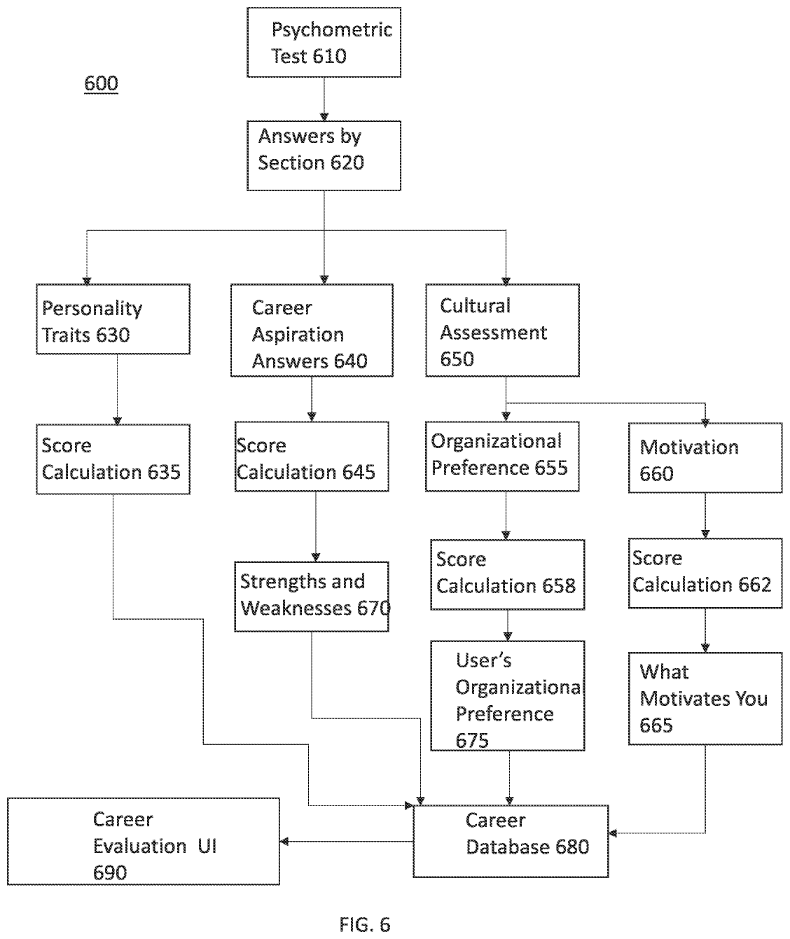

FIG. 3d illustrates another exemplary process in which the candidate participates in additional testing. Exemplarily, in step 326, the candidate answers questions to psychometric testing. These answers are then categorized in step 328. Next, in step 330, the candidate's answers are scored for different potential categories. As discussed below in FIG. 6, some possible categories can include personality traits, career aspirations, a cultural assessment, and motivation. Other additional psychometric categories can be measured. In step 332, recommendations based on the candidate's answers can be provided.

FIG. 4 illustrates an exemplary embodiment of system 400 configured to extract relevant information from a resume provided by a candidate, to apply machine learning to that resume, and to provide a career path evaluation for the candidate. Exemplarily, a resume 410 is uploaded to the system. The upload can be directly performed via an app, a website, or from a database. Many different formats can be provided and analyzed, including, for example word documents and pdf files. Once the resume is acquired, the resume undergoes preprocessing where content is extracted via a resume extraction module 420.

Exemplarily, the resume extraction module 420 can process the resume by scanning the resume file using optical character recognition to convert the resume into machine-encoded text. In some embodiments, this process can be similar to FIG. 2a in which a tagging engine 210, data conversion engine 215, and a data prep engine 225 can be accessed to process the resume data. Data preprocessing can exemplarily cleanse the resume's content. Exemplary preprocessing can include removing numbers and replacing the numbers with empty spaces, removing extra spaces, tokenizing text, as well as removing stop words and punctuation. In additional embodiments, lemmatization can be performed on the resume's content. Exemplarily, lemmatization can normalize the content of the resume into consistent words and phrases. In one example, various instances of the words such as “management”, “managed”, and “manage” can be normalized to simply state “manage” as a tagged keyword. Exemplarily, the data from the resume is then prepared to make it suitable for modeling. The exemplary data preparation step involves converting the textual data to a machine-readable format. An algorithm can exemplarily vectorize the text into numbers. These numbers can then be counted to take the relative frequency of each word in the entire body of the resume.

This transformed data can then be passed to the Machine Learning Model 450 to update a machine learning model. Exemplarily, the machine learning model 450 can be trained based on a training data set that determines target variables that are developed and provided by module 430 and analyzed by a multi-layered neural network 440. Exemplarily, the candidate's resume and other candidate resumes have been processed and input into learn to associate tagged keywords with various career levels. In addition, other factors can include suitable levels for the candidate, primary industries that the candidates can work in, alternate industries based on the candidate's primary industry experience and the transferable skills of the candidate. The machine learning model can then use these inputs to develop rules that would associate various tagged keywords with career options.

Exemplarily, the machine learning model 450 can then generate rules that can be used to associate tagged keywords in a candidate's resume and/or the processed machine-readable format version of the candidate's resume with appropriate career levels. Additionally, the machine learning model 450 can identify primary industries with the tagged keywords. In additional embodiments, location data for candidates can be matched. In some instances, a match between a job and a resume would only occur if the job's location and a candidate's geographic preference or current location is matched. Additionally, the machine learning model 450 can associate job roles with the tagged keywords. As the machine learning model 450 updates the rules for respective primary and/or alternative industries, career levels, job roles, and locations, the rules are continuously provided to the rules-based engine 445.

Exemplarily, the multi-layer neural network 440 can be implemented to assess the training data and target variables. Exemplarily, a multi-label classification model is created using various neural networks. The neural networks are instructed to analyze the training data. The architecture of the neural network can exemplarily be configured to contain a single hidden-layer with a rectified linear unit activation (i.e., a ReLu activation) to handle non-linearities in data. In one embodiment, the neural network uses an Adam optimizer to minimize the errors and finally uses a sigmoid layer with loss as ‘binary cross-entropy’ to associate each resume to different classes.

In one embodiment, as discussed below, the model can be created by merging some or all training data, preprocessing the data derived from the resume's contents, vectorizing those contents as well as the levels, and/or defining a keras model. In one embodiment, the keras model fits the model using the vectorized resume content and levels. These vectorizers and the model can be provided to and saved in module 450. Exemplarily, the KNN algorithm will provide results that indicate different career levels and/or paths that can be used as career option for the candidate.

Exemplarily, a rules-based engine 445 can apply rules from the machine learning model 450 to the processed resume to find potential primary industries, career levels, job roles, and locations for the candidate based on keyword matching. Based on matching career words, the candidate can be matched to certain job roles at an appropriate level. In addition, the rules-based engine 445 can also make determinations based on relevant location data for the candidate and a perspective job. For example, one candidate can be placed in an executive level or a supervisory role based on his resume data while another candidate can be placed in a more introductory career role based on his resume data. In an instance in which a candidate is matched with a position at a matching career level, job role, and/or location, these matched jobs can be provided to the career database 470. In addition, the machine learning model 450 can be provided with update information regarding these matches. In other instances, in which few or no jobs are matched to the candidate, this information is likewise provided to the machine learning model 450 for analysis. The analysis performed by the machine learning model 450 can also include a communication with a prediction engine 460 that can predict alternate industries that the candidate may be qualified for.

In one embodiment, the rules-based engine 445 can apply a k-nearest neighbors (KNN) algorithm to predict the candidate's potential career levels. In additional embodiments, other applicable models and algorithms can be applied to the resume data. Exemplarily, the KNN algorithm can apply the resume data to K nearest neighbors, using stored available cases, and classifying a case or candidate based on a similarity measure to the neighbors. In some instances, no matches can be found, no acceptable matches are found, or other scenarios may be identified in which determinations may be made to suggest alternative career paths and/or industries for the candidate. In occasions where an alternative career path is applicable, the rules-based engine 445 can provide relevant information to the machine learning model 450 and then the machine learning model 445 communicates with prediction engine 460 and the alternative industry rules-based engine 465 for alternative career paths.

In additional exemplary embodiments, the similarity function would be applied to the candidate's resume. In one embodiment, the resume's text would be converted to a lower-case sentence, stop words would be removed from the resume, and non-ascii text can be removed. A term frequency—inverse document frequency (TF IDF) algorithm can then be applied to that data, the TF IDF algorithm can be used to calculate the frequency of each word in a document and then store that data in a vector form. Next, text is generated from the vector generated from TF IDF algorithm. The generated text is passed to the Nearest Neighbor function which is used to generate a score. This score is exemplarily used to create the classification, and to groups all similar resumes.

In one embodiment, the Nearest Neighbor function first finds a distance that is calculated using the Nearest Neighbor based on that score is calculated, in one example, if distance==1, then the score is 0.5 and if the distance <0.9 then the score is 1/score, else the score is =1. Based on the score from the similarity function, and the score calculated from the rule-based engine and the skills that are assigned to the candidate. Based on the job role/transferable skills of the resume, synonyms are checked and options in different domains are suggested.

Based on the neural network's analysis of the training data and target variables, the candidate's career levels, applicable primary industries, job roles, and job locations can be assessed at prediction engine 460 to generate alternative industries. Based on the primary industry's parameters, the rules-based engine can also predict an alternative industry with similar career scoring provided by the KNN algorithm as exemplarily illustrated at module 465. Exemplarily, the candidate's transferable skills can by derived by using a KNN similarity algorithm, among other possible algorithms. Exemplarily, the prediction engine 460 can use these predictions to access alternative rules from the machine learning module 450. These alternative rules may simply be career path rules that have been previously generated that are intended for different career paths that were not previously considered by the rules-based engine 445. In some embodiments, the rules for those different career paths may be provided to the alternative industry rules-based engine 465 where a similar process of comparison is applied to the candidate's resume data to provide alternative industry recommendations based on matches that occur. Exemplarily, several different rules selected by the prediction engine 460 from the machine learning model 450 can be applied to the candidate's data at the alternative industry rules-based engine 465. The outcomes of these searches can be provided back to the machine learning model 450 for additional analysis.

In other embodiments, job roles, career levels, and locations can be checked from information contained within the career/resume database 470, which may contain job data along with similar roles for the candidate. For example, if the job role is ‘Big Data Analytics’, the following list includes similar jobs that can be suggested to the candidate:

1. Big Data

2. Data Analytics

3. Data Science

4. Data Mining

5. Hadoop

6. IoT

7. Machine Learning

8. MapReduce

9. R

10. NoSQL

11. Customer Insights

Exemplarily, once the resume is uploaded, tags or labels can be entered by a Super Admin/Administrator. For the model training and creation module 430, the data for training can be obtained from the ‘resumes’ database. In one example, a “dsp_resumes” database can be accessed to retrieve resumes with ‘islabelled’ flag=True where the “resumecontent” flag is not null. In additional examples, data from the “resume mapping” file can also be collected. In some instances, the training data can be predefined. Once the data is collected from these different sources it is gathered together to generate final training data set. Other data sources can also be applied to generate the final training data set. In one embodiment, the predefined levels are retrieved in the form of an abbreviation and in full form from the “Level_Dict” file which can be known as a dictionary.

In some embodiments, applicable career levels are searched in the training data set content and if found, the full form is replaced with the abbreviation (for example, Chief Executive Officer may be replaced with CEO) and resume content for the training data is created. In some embodiments, career levels can be searched in the training data set content and if found, the full form is replaced with the abbreviation (that is, Chief Executive Officer can be replaced with CEO) and resume content is achieved. Exemplarily, a sequential API can be used to create potential models layer-by-layer based on training data set. Exemplarily, this process enables the model to update itself.

Exemplarily, the results from the primary industry assessment provided by the rules-based engine 445 and the alternative industry assessment from the alternative industry rules-based engine 465 can be provided to the career/resume database 470. A career path evaluation UI 480 can then access the career/resume database 470 to provide the predicted primary industries and alternative industry outcomes to the candidate.

FIG. 5 illustrates an exemplary method 500 for evaluating resumes according to embodiments of the invention. In Step 510, a candidate's resume can be uploaded to a resume database in Step 520. In method 500, the resume may be exemplarily be evaluated and preprocessed to determine likely career outcomes and suggestions for the candidate. Exemplary embodiments of the resume evaluation method include checking the quality of the user's resume in term of information completeness, the quality of words used, quality of lines used etc. in step 530. The resume evaluation can further check whether the resume contains typical, relevant resume details such as a summary, educational details, certifications and languages known, among other details. In some embodiments, a file containing action words can be created for different sections of the candidate's resume. Next, the candidate's resume can be checked to determine if the resume contains any actions words present in the action word file within each section. The action words can be calculated for the peer group as well.

In some embodiments, the user's contact information can be checked in the resume. Checking the contact information includes the checking the candidate's Username, Email ID, Phone Number and LinkedIn URL. Based on the levels recommended to the user in “Career Advancement Report/Career Evaluation output described above”, all the users who are currently at that level are identified and their resumes are collected from the peer database. Next, in Step 538, the length of the resume is checked by counting the number of words in the resume. The average length can also be calculated for the peer database in Step 535. In Step 535, the number of lines indicating a user's measurable impact is calculated from the resume. For instance, where a user mentions how he contributed by adding to the sales in business or to revenue in a business can be considered part of the user's measurable impact. Similarly, measurable impact lines can be collected and/or calculated for the peer group, as exemplarily illustrated in steps 550 and 560. In additional embodiments, the number of passive sentences found in the candidate's resume can be calculated using a parts-of-speech tagging method.

The method 500 can also provide a comparative analysis of the user's resume with respect to a peer group, where peers of the candidate include resumes of users at those levels which have been recommended to the user as career advancement. In Step 540, the comparable level with a peer group can be predicted to exemplarily determine which group of peers the candidate's resume should be compared against. In Step 550, a set of benchmark resumes for the peer group can be collected. In Step 560, a peer group is generated for the candidate.

Next, in Step 570, the candidate's resume is compared against the peer group. As discussed above with respect to FIG. 2c, an exemplary comparison to the peer group can include a qualitative assessment and/or a quantitative assessment. As discussed above, a quality assessment can compare the candidate user's resume content with his or her peer group to identify the features the candidate has in common with the members in the same level, the features he/she needs to improve in order to be compatible with the peer group and the modifications that can be done in his resume to make it more appealing when compared to his/her peer group. It also evaluates the candidate's resume by assigning a score for each of these features. Other qualitative assessments can be performed such as determining if common action words are present in the candidate resume or applying an impact check such as impact checker 250 of FIG. 2.

Exemplary quantitative assessments can identify deficient sections of the user candidate's resume. For example, one or more of the following sections can be checked: summary, educational details, certifications and languages known, etc. If any of these or other sections are missing, a notification may be generated. The resume content can be compared with a resume section list to identify the sections that are present in the resume. Scores corresponding to the presence/absence of each section is also added to the total resume score. Other quantitative assessments can be performed.

In step 580, the user-scores and the peer group scores are then sent to the database which are then used to populate the Resume Evaluation Reports. The user's scores across different categories are aggregated to generate the overall resume score at the resume evaluation user interface in step 590.

FIG. 6 illustrates an exemplary method 600 according to embodiments of the present invention. Method 600 provides exemplary methods for analyzing a candidate's career aptitude and other traits to find career recommendations for that candidate. Exemplary embodiments of the present invention can start with a candidate user undertaking a psychometric evaluation or testing in step 610 of method 600. In step 610, the user can undergo several exemplary psychological and sociological tests. These tests can be answered by sections according to applicable career paths and follow-up choices in step 620. The psychometric testing sections can include personality traits, career aspiration answers, and a cultural assessment of that candidate as well as other potential psychometric testing as determined by other embodiments of method 600.

Exemplarily, the candidate will take on or more psychometric test as part of generating the candidate's career assessment. The candidate's responses can then be stored in a ‘test answers’ database collection in Step 680. Next, feedback files are fetched for each user after they have completed a psychometric test. In taking the psychometric test, for each user response, a section to which the response belongs are stored. For the section ‘Personality Trait’, the average score for each question with the same ‘type’ value is calculated, and the score range is found.

In one embodiment, the answers by section can include personality trait questions and analysis as indicated in exemplary step 630 of method 600. Various personality traits can be determined from the psychometric testing of step 610 and the scores from these tests can be evaluated in step 635. Similarly, the candidate's career aspirations can be analyzed from the answers in step 640 and a career aspiration score can be calculated in step 645.

In one example of determining a score range, there could be a hypothetical section which has 4 questions and the scores range from 1 to 5. In this example, the scores achieved by a user could be 3, 2.33, 4, 2.4 leading to an average score of 2.9325. In other embodiments, some questions could be weighted differently from other questions in the psychometric test or in different sections of the test. Next, based on certain defined thresholds, the candidate's score can fall into a field of score ranges. In one such example, the score range could be sorted in a spread from High to Medium and to Low. For example, High could include test scores from 3.68 to 5; Medium from 2.34 to 3.67; and Low from 1 to 2.33.

In another example, a cultural assessment can be generated based on the candidate's answers in step 650. For the section ‘Cultural Assessment’ and subsection ‘Type 1’, the score and data for generating the graph is calculated. Next, for the section ‘Cultural Assessment’ and subsection ‘Type 2’, the average score for the questions with same ‘type’ value is calculated, the score range is found. For each level, the required score for each of the personality trait is calculated and compared against the user's score. The cultural assessment can also inform an analysis of the candidate's career motivations in step 660 and the score for the candidate's motivation can be calculated in step 662.

Based on the scores generated in steps 635, 645, 658, and 662, the candidate's Strengths and Areas of Improvement for each level can be identified in step 670. Next, feedback corresponding to each response from the feedback file can then be obtained. These scores can be stored in the database in step 680 and passed to the Career Evaluation UI in step 690. In some embodiments, the candidate's highest personality trait is identified and displayed on the UI. In addition, an average score associated with each level, for example a 41 level could be considered equivalent to a CEO or COO status or rank would also be displayed on the UI.

For each of the personality traits, a feedback could be generated or predefined. For example, in one example, the candidate is provided with feedback on how to leverage a trait associated with a high score. In one instance, this can be feedback on what is it a candidate could do to leverage a high score on emotional stability. In another example, if the candidate has a low or medium personality trait scores, a suggestion could be provided to advise what could be done to cover gaps (e.g., if the candidate's storytelling score is low) to recommend what books could be read, courses that can be taken, or projects that can be completed to compensate for those lower scores. In some embodiments, the feedback can be stored such that the recommendations are based on hard rules where the responses are aligned with and provided in response to predetermined scores for that test section.

In another instance, career aspiration gaps can be identified. In exemplary embodiments, career aspirations gaps can occur where key personality and leadership traits are identified that are generally required to perform certain key roles in various careers similar to the manner of the career aspiration engine 290 of FIG. 2d. The candidate's score can be measured against these known scores and suggested areas of improvement that a candidate should focus on can be provided to the candidate. In some instances, an ideal score for each personality trait for a particular job role is already specified in the system. Next, based on the candidate's scores, the traits are compared with each job role. In some embodiments, important traits can be identified based on the Job Role Traits identification ranking as low, medium, or high. Exemplarily, the system can also identify the candidate's strengths and weakness, as well as any career or technical gaps. For example, the strength calculator 280 exemplarily identified in FIG. 2d can be used to generate the candidate's strengths and weaknesses.

The results of this analysis can be then compiled and presented in a visual manner for the candidate. In some instances, career gaps can be displayed visually with the Ideal values and the candidate's values. Similarly, the same process can be applied for any technical gaps identified for the candidate.

In additional embodiments, the candidate's organizational preferences can be assessed in step 675. Exemplarily, the organizational preference can be determined based on the score calculation derived in step 658. In other embodiments, a score based on the candidate's motivational assessment can be derived in step 662 to provide an identification of that candidate's motivations in step 665. Exemplarily, the outcomes consisting of the personality trait score calculation of step 635, the candidate's strengths and weaknesses scores from step 670, the candidate's organizational preferences from step 675, and motivation from step 665 can be provided to the career database in step 680.

In addition, the machine learning model can be updated to identify what technical gaps are through developing training data sets to identify common technical skills for each one of these roles. The outcomes of the various score calculations can be provided to a career database in step 680 and a career evaluation UI can provide the information to the candidate in step 690.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

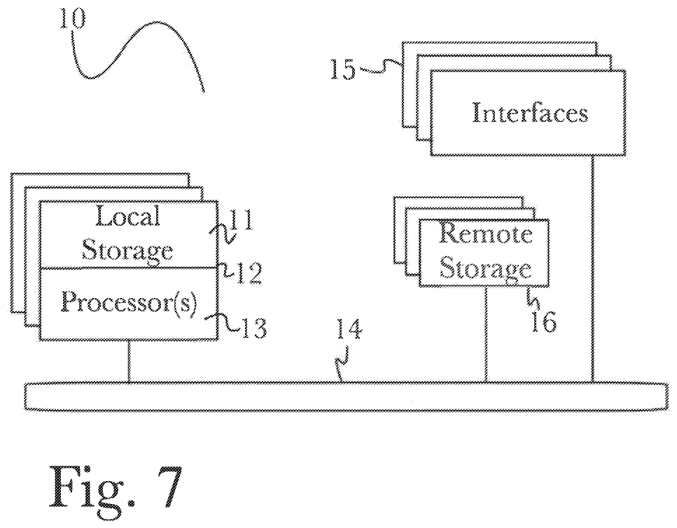

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some embodiments, systems may be implemented on a standalone computing system. Referring now to FIG. 8, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

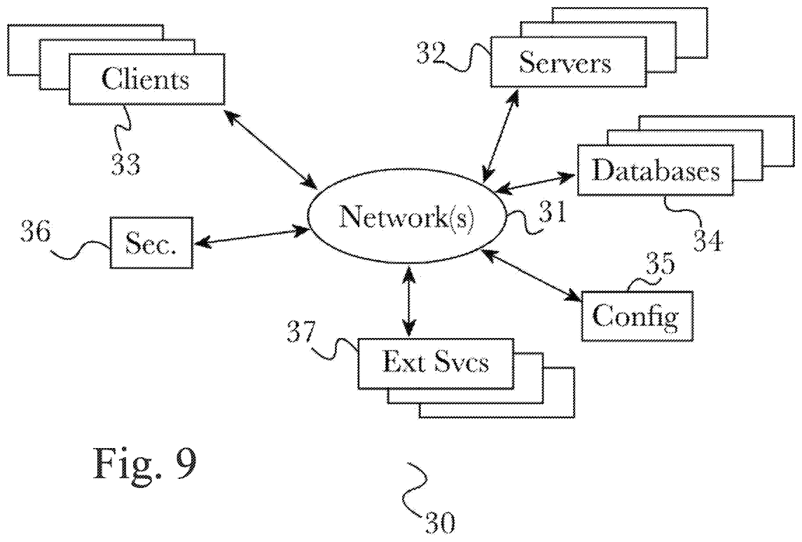

In some embodiments, systems may be implemented on a distributed computing network, such as one having any number of clients and/or servers. Referring now to FIG. 9, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 8. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

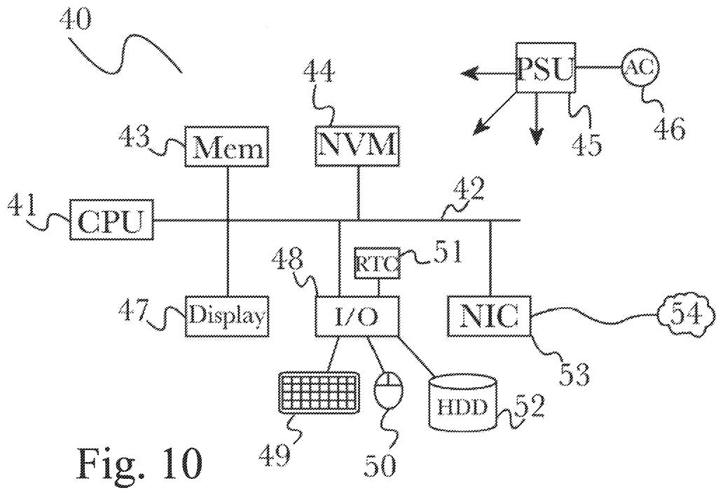

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer program product comprising a non-transitory computer readable storage medium having instructions encoded thereon that, when executed by a processor, cause the processor to:
receiving a resume from a candidate;
processing the resume to generate machine-readable candidate resume data;
providing the machine-readable candidate resume data to a rules-based engine to generate matching career levels for the candidate;
providing the machine-readable candidate resume data to an alternative career rules-based engine to generate alternative career levels for the candidate; and
generating a candidate report including the matching career levels and the alternative career levels.

2. The computer program product of claim 1, wherein the processing the resume further comprises instructions to identify a peer group comparable to the machine-readable candidate resume data.

3. The computer program product of claim 2, wherein the processing the resume further comprises comparing the machine-readable candidate resume data to respective resumes of the peer group.

4. The computer program product of claim 3, wherein the processing the resume further comprises generating an impact score for the machine-readable candidate resume data according to a generic impact score for the peer group.

5. The computer program product of claim 2, wherein the processing the resume further comprises recommending changes to the resume based on a comparison of the machine-readable candidate resume data to resumes of the peer group.

6. The computer program product of claim 1, wherein the rules-based engine receives a career model from a machine learning system comprising career level rules applicable to the candidate.

7. The computer program product of claim 6, wherein the machine learning system generates a training data set, and wherein the training data set is based on a plurality of resumes and respective career levels for each of the plurality of resumes.

8. The computer program product of claim 7, wherein the machine learning system applies the training data to a neural network to generate a plurality of career level rules, the plurality of career level rules including the career level rules applicable to the candidate.

9. The computer program product of claim, wherein instructions cause the processor to further perform administering a psychometric test for the candidate, wherein answers to the psychometric test are analyzed to provide career recommendations for the candidate report.

10. The computer program product of claim 9, wherein the career recommendations are based on an assessment of candidate personality traits, candidate career aspirations, a candidate organizational assessment, and a candidate motivation assessment.

11. A method, comprising:
receiving, by a processing system comprising a processor, a resume from a candidate;
processing, by the processing system, the resume to generate machine-readable candidate resume data;
providing, by the processing system, the machine-readable candidate resume data to a rules-based engine to generate matching career levels for the candidate;
providing, by the processing system, the machine-readable candidate resume data to an alternative career rules-based engine to generate alternative career levels for the candidate; and
generating, by the processing system, a candidate report including the matching career levels and the alternative career levels.

12. The method of claim 11, further comprising administering a psychometric test for the candidate, wherein answers to the psychometric test are analyzed to provide career recommendations for the candidate report.

13. The method of claim 12, wherein the psychometric test measures one of candidate personality traits, candidate career aspirations, a candidate organizational assessment, and a candidate motivation assessment.

14. The method of claim 11, the method further comprising:
generating a training data set, and wherein the training data set is based on a plurality of resumes and respective career levels for each of the plurality of resumes; and
applying the training data set to create a machine learning model that develops rules associating the respective career levels and tagged keywords from the plurality of resumes.

15. The method of claim 14, the method further comprising:
predicting alternative industries for the candidate resume;
accessing the machine learning model to find alternative rules for the alternative industries; and
providing the alternative rules to the alternative career rules-based engine, wherein the alternative career rules-based engine applies the alternative rules to the machine-readable candidate resume data to generate the alternative career levels.

16. A system, comprising:
a processing system including a processor; and
a memory, coupled to the processing system, that stores executable instructions and that, when executed by the processing system, facilitate performance of operations, comprising:
providing a resume receiving module to receive resume data from a candidate;
providing a resume processing module to process the resume data into machine-readable text;
providing a rules-based engine to generate a career recommendation for the candidate; and
providing a career evaluation interface module to provide the career recommendation to the candidate.

17. The system of claim 16, wherein the operations further comprise:
determining whether the rules-based engine returned job matches for the candidate;
responsive to the rules-based engine returning less than a predetermined number of returned job matches, predicting alternative industries for the candidate resume;
accessing a machine learning model to find alternative rules for the alternative industries; and
providing the alternative rules to an providing an alternative career rules-based engine to generate alternative career recommendations for the candidate, wherein the career evaluation interface provides the alternative career recommendations to the candidate.

18. The system of claim 16, wherein the operations further comprise generating a machine learning model to provide rules to the rules-based engine, wherein the rules-based engine compares the machine-readable text to the rules.

19. The system of claim 18, wherein the generating the machine learning module comprises generating training data to update the model based on the candidate resume and comparable resumes.

20. The system of claim 16, wherein the operations further comprise providing a psychometric testing module to administer a psychometric test for the candidate, wherein answers to the psychometric test are analyzed to provide career recommendations for the candidate report.
